(19) United States
(12) Patent Application Publication
(10) Pub. No.: US 2026/0266622 A1
(43) Pub. Date: Sep. 10, 2026

(54) METHOD AND SYSTEM FOR ADAPTIVELY LOCATING A MOVING OBJECT RELATIVE TO A TARGET OBJECT

(71) Applicant: GRABTAXI HOLDINGS PTE. LTD., Singapore (SG)

(72) Inventors: Thanh Dat LE, Singapore (SG); Hao WU, Singapore (SG); Nuo XU, Singapore (SG); Jiang LIU, Chaoyang District, Beijing (CN); Harald KOERTGE, Cluj Napoca (RO); Chunda DING, Chaoyang District, Beijing (CN)

(21) Appl. No.: 18/876,438

(22) PCT Filed: May 27, 2023
(86) PCT No.: PCT/SG2023/050374

§ 371 Date: Dec. 18, 2024

(30) Foreign Application Priority Data
Jun. 24, 2022 (WO) PCT/CN2022/101286

(51) Int. Cl. G01C 21/00

(52) U.S. Cl. CPC G01C 21/3811; G01C 21/3837

(57) ABSTRACT

The present disclosure provides methods and systems for adaptively locating a moving object relative to a target object. In some examples, there is provided a method for adaptively locating a moving object relative to a target object, the method comprising: identifying a latitude and longitude of a location of the target object, in response to a request message including location information of the target object; identifying a location information of a moving object in the proximity of the target object based on the identified latitude and longitude of the target object; and adaptively locating the moving object relative to the target object based on the identified location information.

### FIELD OF INVENTION

The present disclosure relates broadly, but not exclusively, to methods and systems for adaptively locating a moving object relative to a target object.

### BACKGROUND

One of the fundamental problems for the ride-hailing and delivery industry is to locate nearest moving objects in real-time. This is a well studied problem among ride hailing platform companies. An approach called Network Incremental Expansion (NIE) is commonly used because the algorithm can find K nearest neighbors (KNN) sorted by actual travel distance or travel time.

However, since the algorithm needs to visit all nodes/edges of the search space until one of the termination conditions is met, for example either K nearest neighbors are found or a distance/time limit is exceeded. Therefore, it is a computationally expensive operation. Hence, the classic NIE tends to perform well when the KNN search radius is relatively small (under 5000 meters) and has bad runtime when the search radius is large, for example when searching for KNN in an entire province or city.

A need therefore exists to provide methods and systems that seek to overcome or at least minimize the above mentioned challenges.

### SUMMARY

According to a first aspect of the present disclosure, there is provided a method for adaptively locating a moving object relative to a target object, the method comprising: identifying a latitude and longitude of a location of the target object, in response to a request message including location information of the target object; identifying a location information of a moving object in the proximity of the target object based on the identified latitude and longitude of the target object; and adaptively locating the moving object relative to the target object based on the identified location information.

According to a second aspect of the present disclosure, there is provided a system for adaptively locating a moving object relative to a target object, comprising: at least one processor; and at least one memory including computer program code; the at least one memory and the computer program code configured to, with the at least one processor, cause the system at least to: identify a latitude and longitude of a location of the target object, in response to a request message including location information of the target object; identify a location information of a moving object in the proximity of the target object based on the identified latitude and longitude of the target object; and adaptively locate the moving object relative to the target object based on the identified location information.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 illustrates a system for adaptively locating a moving object relative to a target object according to various embodiments of the present disclosure.

FIG. 2 is a schematic diagram of a locating server, according to various embodiments of the present disclosure.

FIG. 3 is an overview of a process for adaptively locating a moving object relative to a target object, according to various embodiments.

FIG. 4A depicts an example illustration of how phantom nodes are utilized according to various embodiments.

FIG. 4B depicts an example illustration of a moving object storage according to various embodiments.

FIG. 4C depicts an example illustration of an Association Directory comprising a node storage and a partition storage according to various embodiments.

FIG. 5 depicts an example illustration of an architecture framework for adaptively locating a moving object relative to a target object according to various embodiments.

FIG. 6A depicts an example illustration of a moving object update flowchart according to various embodiments.

FIG. 6B depicts an example illustration of an algorithm that may be implemented for the moving object update flowchart according to various embodiments.

FIG. 6C depicts an example illustration of a moving object nearby request flowchart according to various embodiments.

FIGS. 6D-6E depict an example illustration of an algorithm that may be implemented for the moving object nearby request flowchart according to various embodiments.

FIG. 7 illustrates an example flow diagram of a method for adaptively locating a moving object relative to a target object according to various embodiments.

FIG. 8A is a schematic block diagram of a general purpose computer system upon which the locating server of FIG. 2 can be practiced.

FIG. 8B is a schematic block diagram of a general purpose computer system upon which a combined transaction processing and locating server of FIG. 1 can be practiced.

FIG. 9 shows an example of a computing device to realize the transaction processing server shown in FIG. 1.

FIG. 10 shows an example of a computing device to realize the locating server shown in FIG. 1.

FIG. 11 shows an example of a computing device to realize a combined transaction processing and locating server shown in FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

### Terms Description

A platform refers to a set of technologies that is used as a base for facilitating exchanges between two or more interdependent servers, entities and/or devices, for example between a requestor device (of a product or service) and a provider device (of the product or service). For example, a platform may offer a service offered by a provider such as a ride, delivery, online shopping, insurance, and other similar services to a requestor. The requestor can typically access the platform via a website, an application, or other similar methods. In the present disclosure, a requestor of a ride is also termed as a target object, and a provider of the ride is also termed as a moving object.

A request message may refer to a request for a ride, or a request for locating a moving object relative to a target object. The request message may originate from the target object and transmitted from a requestor device to a server or device associated with the platform, and may include location information of the target object. This location information may include GPS coordinates that are used for identifying a latitude and longitude of a location of the target object. The location of the target object may also be referred to as a query point. The locating of the moving objects that are in proximity to the given location information is then based on the latitude and longitude. Each located moving object may be associated with a graph partition. A graph edge may also be partitioned based on location information of each located moving objects. The graph edge refers to a representation of a relative location of a target object or moving object on a road graph, where the road graph comprises a road network. The mapping and partitioning of a graph edge may involve retrieving and/or updating data relating to associations between each object to a corresponding graph partition, as well as data relating to road networks that are derived from, for example, OpenStreetMap (OSM) graphs.

In at least some embodiments, a user may be any suitable type of entity, which may include a person, a consumer looking to purchase a product or service via a transaction processing server, a seller or merchant looking to sell a product or service via the transaction processing server, a motorcycle driver or pillion rider in a case of the user looking to book or provide a motorcycle ride or delivery via the transaction processing server, a car driver or passenger in a case of the user looking to book or provide a car ride or delivery via the transaction processing server, a deliverer who is travelling by bicycle, electric mobile vehicle (EMV) or on foot to provide a delivery service via the transaction processing server, and other similar entity. A user who is registered to the transaction processing or locating server will be called a registered user. A user who is not registered to the transaction processing server or locating server will be called a non-registered user. The term user will be used to collectively refer to both registered and non-registered users. A user may interchangeably be referred to as a requestor (e.g. a person who requests for a product or service for example by sending a request message) or a provider (e.g. a person who provides the requested product or service to the requestor).

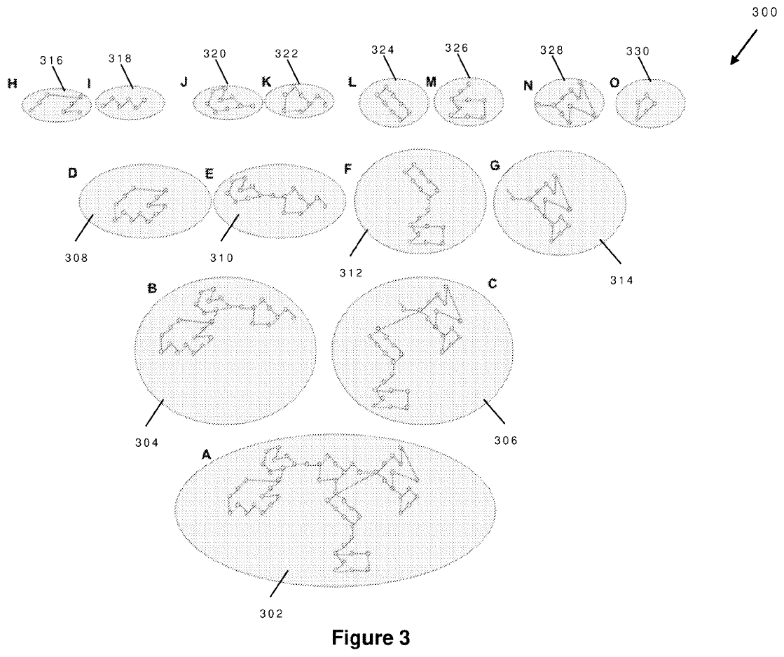

In at least some embodiments, a locating server is a server that hosts software application programs (for example, Pharos©) for adaptively locating a moving object relative to a target object. The locating server may be implemented as shown in schematic diagram 300 of FIG. 3 for adaptively locating a moving object relative to a target object.

In at least some embodiments, a transaction processing server is a server that hosts software application programs for processing payment transactions for, for example, a travel-ordination request, purchasing of a good or service by a user, and other similar services. The transaction processing server communicates with any other servers (e.g., a locating server) concerning processing payment transactions relating to the purchasing of the good or service, such as a travel co-ordination request. For example, data relating to a request message such as a travel co-ordination request or a KNN query (e.g. date, time, location information of the user making the request or query, and other similar data) may be provided to the locating server and processed to locate moving objects that are in proximity to the user location. The transaction processing server may use a variety of different protocols and procedures in order to process the payment and/or travel co-ordination requests.

Transactions that may be performed via a transaction processing server include product or service purchases, credit purchases, debit transactions, fund transfers, account withdrawals, etc. Transaction processing servers may be configured to process transactions via cash-substitutes, which may include payment cards, letters of credit, checks, payment accounts, etc.

In at least some embodiments, the transaction processing server is usually managed by a service provider that may be an entity (e.g. a company or organization) which operates to process transaction requests and/or travel co-ordination requests e.g. pair a provider of a travel co-ordination request to a requestor of the travel co-ordination request. The transaction processing server may include one or more computing devices that are used for processing transaction requests and/or travel co-ordination requests.

In at least some embodiments, a transaction account is an account of a user who is registered at a transaction processing server. The user can be a customer, a merchant providing a product for sale on a platform and/or for onboarding the platform, a hail provider (e.g., a moving object), or any third parties (e.g., a courier) who want to use the transaction processing server. In certain circumstances, the transaction account is not required to use the transaction processing server. A transaction account includes details (e.g., name, address, vehicle, face image, etc.) of a user. The transaction processing server manages the transaction.

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “locating”, “identifying”, “determining”, “associating”, “mapping”, “partitioning”, “processing”, “storing”, “aggregating”, “calculating”, or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Incremental Network Expansion (INE) refers to a technique implemented by an algorithm for finding K nearest neighbors (KNN) sorted by actual travel distance or travel time. This technique is commonly utilized by ride hailing platforms and may be implemented in applications such as Pharos©.

OpenStreetMap (OSM) is a free and open source editable map maintained by its community. Pharos© uses the map which is extracted from the OSM base map for its graph representation of road topology. This base map, represented as a raw OSM protobuf file, will be processed to generate a multi-level Dijkstra (MLD) graph.

Pharos© refers to an application that supports large-volume, real-time K nearest search by driving distance or ETA with high object update frequency. OSM graphs may be used in Pharos© to represent road networks. The OSM graph may be partitioned by cities and verticals (e.g. the road network for a four-wheel vehicle is different compared to a motorbike or a pedestrian). A partition key for a graph partition may be denoted as a map ID. Pharos© loads the graph partitions at service start and stores drivers' spatial data in memory in a distributed manner to alleviate the scalability issue when the graph or the number of drivers grows. To answer a KNN query by routing distance or estimated time of arrival (ETA), Pharos uses INE starting from the road segment of a query point (e.g. a location to which the KNN query relates, for example a location for a driver to pick up a user). During the expansion, drivers stored along the road segments are incrementally retrieved as candidates and put into the results. The expansion generates an isochrone map, and can be terminated upon reaching a predefined radius of distance or ETA, or even simply a maximum number of candidates. As the drivers are typically moving around the road networks while the search is performed, the object associated with a driver may be referred to as a moving object, while the requestor associated with the KNN query may be referred to as a target object.

Min-cut max-flow theorem refers to a network flow theorem which states that the maximum flow through any network from a given source to a given sink is exactly the sum of the edge weights that, if removed, would totally disconnect the source from the sink. In other words, for any network graph and a selected source and sink node, the max-flow from source to sink=the min-cut necessary to separate source from sink. Flow can apply to anything. For instance, it could mean the amount of water that can pass through network pipes, or it could mean the amount of data that can pass through a computer network like the Internet. In the present disclosure, a min-cut max-flow algorithm is one that functions based on the min-cut max-flow theorem, and may be implemented for partitioning a road network, wherein the flow may be interpreted as relating to a number of moving objects (e.g. drivers) in the road network.

There are a few challenges to serve a large radius KNN in real time. From business requirements, K nearest objects need to be calculated by actual routing distance instead of straight line distance. When processing the KNN query with a large search radius, the classical approach like INE becomes computationally expensive because the search space is exponentially correlated with the search radius, making it a non-scalable solution. Further, the objects to be searched and located during a KNN search are constantly changing at different velocities in the road network. These updates need to be reflected in the search result in real time. By overcoming the challenges above, the proposed solution can be highly efficient for searching K-number of moving objects within an entire city or even within a country. Furthermore, the algorithm can advantageously be extended to be able to search any type of spatial object within a large radius (for example~100 km).

In the present disclosure, an improvement to the classic INE (which is using a computationally expensive method traversing the road network for distance computation) is proposed by utilizing search space pruning. Search space pruning can be very efficient for spatial objects because in reality, spatial objects often cluster in certain areas, e.g., highly populated residential neighborhoods, the central business district. There is thus an opportunity for optimisation as many areas which do not contain any spatial objects can be skipped. The KNN query's search space can advantageously be reduced significantly, hence, improving its runtime complexity.

To support the operation mentioned above, a way is required to efficiently partition a road network into reasonably sized partitions and actively maintain the association between the object's location to the road network and to the road network partitions. For example, the road network is recursively splitted into multi-layer partitions by the min-cut max-flow algorithm. By doing a series of minimum “natural cut” computations, the algorithm can identify and preserve dense areas in the map while maintaining the natural structure of the network in each partition.

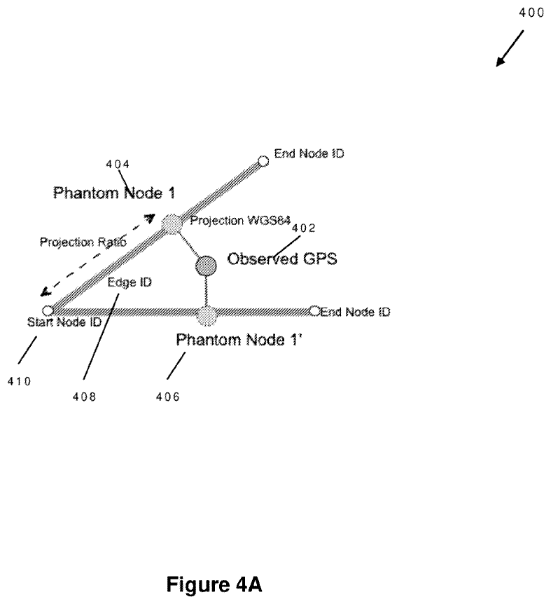

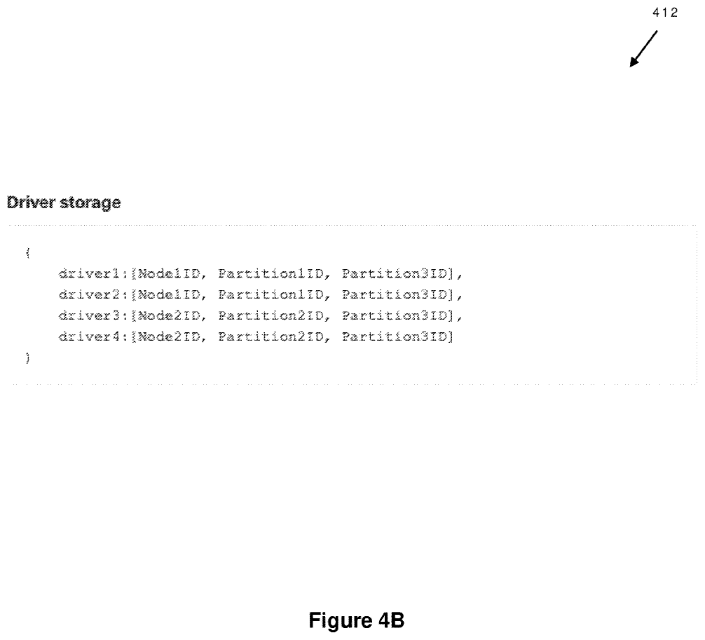

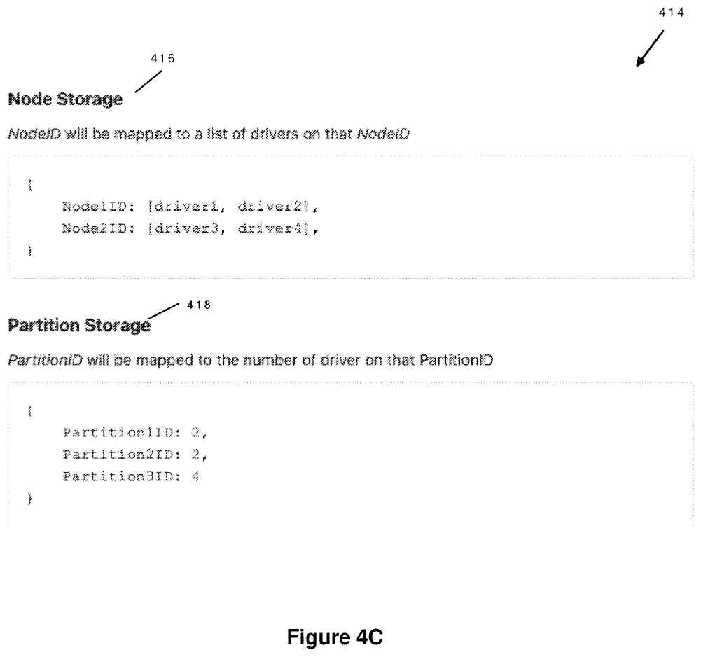

The proposed solution may be implemented in Pharos© as a scalable in-memory solution and for supporting large-volume, real-time K nearest search by driving distance or ETA with high object update frequency. Pharos© may store both map data and object's spatial data as well as the association between each object to the partitions in a moving object storage and Association Directory. Pharos© may use multiple concurrent hashMaps to maintain the mapping between a moving object's location to the road network. For example, during a moving object update operation, the moving object's location is snapped onto the road network to get its relative location in the road graph (the graph edgeID, relative distance to the edge's startNode and which partition at all levels the edge is enclosed by). This information together with object's metadata are eventually stored into the in-memory object storage. While performing KNN search, starting from a query point, Pharos© may be configured to expand the road network while actively checking if it can skip certain object empty partitions by looking up the Association Directory and moving object storage. The moving object storage and Association Directory are further explained in FIGS. 4A and 4B respectively.

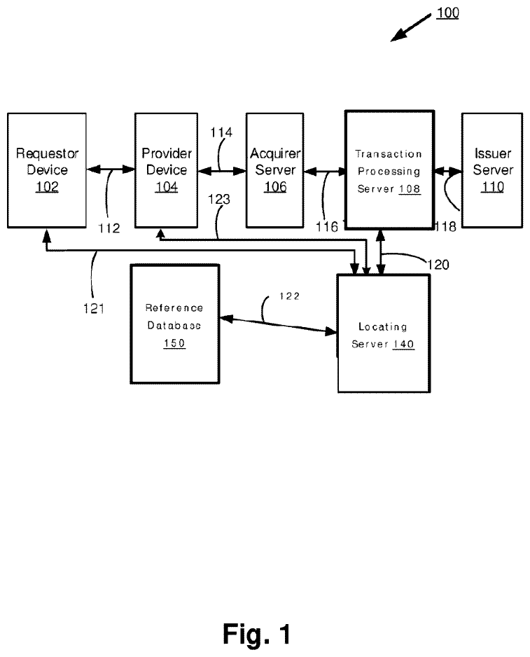

FIG. 1 illustrates a block diagram of an example system 100 for adaptively locating a moving object relative to a target object. In some embodiments, the system 100 enables a payment transaction for a good or service, and/or a request for a ride or delivery of a physical item (e.g. one or more food items or a parcel) between a requestor and a provider.

The system 100 comprises a requestor device 102, a provider device 104, an acquirer server 106, a transaction processing server 108, an issuer server 110, a locating server 140 and a reference database 150.

The requestor device 102 is in communication with a provider device 104 via a connection 112, and may be associated with a target object during a KNN query search when locating a moving object relative to a target object. The connection 112 may be wireless (e.g., via NFC communication, Bluetooth, etc.) or over a network (e.g., the Internet). The requestor device 102 is also in communication with the locator server 140 via a connection 121, wherein the locating server 140 may be configured to receive location information of the requestor device 102 (and therefore location information of the associated target object). The connection 121 may be via a network (e.g., the Internet). The requestor device 102 may also be connected to a cloud that facilitates the system 100 for adaptively locating a moving object relative to a target object. For example, the requestor device 102 can send a signal or data to the cloud directly via a wireless connection (e.g., via NFC communication, Bluetooth, etc.) or over a network (e.g., the Internet).

The provider device 104 is in communication with the requestor device 102 as described above, usually via the transaction processing server 108, and may be associated with a moving object during a KNN query search when locating a moving object relative to a target object. The provider device 104 is, in turn, in communication with an acquirer server 106 via a connection 114. The provider device 104 is also in communication with the locator server 140 via a connection 123, wherein the locator server 140 may be configured to receive location information of the provider device 104 (and therefore location information of the associated moving object). The connections 114 and 123 may be via a network (e.g., the Internet). The provider device 104 may also be connected to a cloud that facilitates the system 100 for adaptively locating a moving object relative to a target object. For example, the provider device 104 can send a signal or data to the cloud directly via a wireless connection (e.g., via NFC communication, Bluetooth, etc.) or over a network (e.g., the Internet).

The acquirer server 106, in turn, is in communication with the transaction processing server 108 via a connection 116. The transaction processing server 108, in turn, is in communication with an issuer server 110 via a connection 118. The connections 116 and 118 may be via a network (e.g., the Internet).

The transaction processing server 108 is further in communication with the locating 140 via a connection 120. The connection 120 may be over a network (e.g., a local area network, a wide area network, the Internet, etc.). In one arrangement, the transaction processing server 108 and the locating server 140 are combined and the connection 120 may be an interconnected bus.

The locating server 140, in turn, is in communication with the reference database 150 via respective connection 122. The connection 122 may be over a network (e.g., the Internet). The locating server 140 may also be connected to a cloud that facilitates the system 100 for adaptively locating a moving object relative to a target object. For example, the locating server 140 can send a signal or data to the cloud directly via a wireless connection (e.g., via NFC communication, Bluetooth, etc.) or over a network (e.g., the Internet).

The reference database 150 may comprise data that is utilized by the locating server 140 for adaptively locating a moving object relative to a target object. For example, the moving object storage and Association Directory may be stored in the reference database 150. For example, data relating to the moving object storage and Association Directory such as map data, object spatial data, data relating to associations between each object to a corresponding graph partition, may be stored in the reference database 150. Further, data relating to OSM graphs may also be stored in the reference database 150. In an implementation, the reference database 150 may be combined with the locating server 140. In an example, the reference database 150 may be managed by an external entity.

The locating server 140 may, based on location information of a target object indicated in a request message (e.g. the request being provided by a user), identify a latitude and longitude of a location of the target object. The locating server 140 may then be configured to identify a location information of a moving object in the proximity of the target object based on the identified latitude and longitude of the target object, and adaptively locate the moving object relative to the target object based on the identified location information. The association of the moving object and target object may involve retrieving and/or updating the data relating to the moving object storage and Association Directory such as map data, object spatial data, data relating to associations between each object to a corresponding graph partition which may be stored in the reference database 150.

The locating server 140 may be further configured to identify location information of a road network that one or more target objects are travelling on, identify a relative distance of a starting position of each of the one or more target objects, and map the one or more moving objects relative to the target object, and partition a graph edge based on location information of each of the one or more moving objects. The mapping and partitioning of graph edge may involve retrieving and/or updating the data relating to associations between each object to a corresponding graph partition, as well as data relating to the road networks that are derived from the OSM graphs which may be stored in the reference database 150.

In an implementation, there may be more than one reference databases, in which the locating server 140 may be configured to determine which database to use for each step during processing of a KNN query request. Alternatively, one or more modules may store the above-mentioned data instead of the reference database 150, wherein the module may be integrated as part of the locating server 140 or external from the locating server 140.

In the illustrative embodiment, each of the devices 102, 104, and the servers 106, 108, 110, 140, and/or reference database 150 provides an interface to enable communication with other connected devices 102, 104 and/or servers 106, 108, 110, 140, and/or reference database 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for at least one of the requestor device 102 and the provider device 104 to send data relating to, for example, location information of a target object and moving object respectively, a in response to an enquiry shown on the GUI running on the respective API.

Use of the term ‘server’ herein can mean a single computing device or a plurality of interconnected computing devices which operate together to perform a particular function. That is, the server may be contained within a single hardware unit or be distributed among several or many different hardware units.

The locating server 140 is associated with an entity (e.g. a company or organization or moderator of the service). In one arrangement, the locating server 140 is owned and operated by the entity operating the transaction processing server 108. In such an arrangement, the locating server 140 may be implemented as a part (e.g., a computer program module, a computing device, etc.) of the transaction processing server 108.

The transaction processing server 108 may also be configured to manage the registration of users. A registered user has a transaction account (see the discussion above) which includes details of the user. The registration step is called on-boarding. A user may use either the requestor device 102 or the provider device 104 to perform on-boarding to the transaction processing server 108.

It may not be necessary to have a transaction account at the transaction processing server 108 to access the functionalities of the transaction processing server 108. However, there are functions that are available to a registered user. These additional functions will be discussed below.

The on-boarding process for a user is performed by the user through one of the requestor device 102 or the provider device 104. In one arrangement, the user downloads an app (which includes the API to interact with the transaction processing server 108) to the requestor device 102 or the provider device 104. In another arrangement, the user accesses a website (which includes the API to interact with the transaction processing server 108) on the requestor device 102 or the provider device 104. The user is then able to interact with the locating server 140. The user may be a requestor or a provider associated with the requestor device 102 or the provider device 104, respectively.

Details of the registration may include, for example, name of the user, address of the user, emergency contact, blood type or other healthcare information, next-of-kin contact, permissions to retrieve data and information from the requestor device 102 and/or the provider device 104 for adaptively locating a moving object relative to a target object, such as permission to retrieve location information of the requestor device 102 and/or the provider device 104. Alternatively, another mobile device may be selected instead of the requestor device 102 and/or the provider device 104 for retrieving the data. Once on-boarded, the user would have a transaction account that stores all the details.

The requestor device 102 is associated with a customer (or requestor) who is a party to a transaction that occurs between the requestor device 102 and the provider device 104, or between the requestor device 102 and the locating server 140. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 may be associated with a target object during a KNN query search when locating a moving object relative to a target object.

The requestor device 102 includes transaction credentials (e.g., a payment account) of a requestor to enable the requestor device 102 to be a party to a payment transaction. If the requestor has a transaction account, the transaction account may also be included (i.e., stored) in the requestor device 102. For example, a mobile device (which is a requestor device 102) may have the transaction account of the customer stored in the mobile device.

In one example arrangement, the requestor device 102 is a computing device in a watch or similar wearable and is fitted with a wireless communications interface (e.g., a NFC interface). The requestor device 102 can then electronically communicate with the provider device 104 regarding a transaction request. The customer uses the watch or similar wearable to make request regarding the transaction request by pressing a button on the watch or wearable.

The provider device 104 is associated with a provider who is also a party to the transaction request that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. The provider device 104 may be associated with a moving object during a KNN query search when locating a moving object relative to a target object.

Hereinafter, the term “provider” refers to a service provider and any third party associated with providing a product or service for purchase, or a travel or ride or delivery service via the provider device 104. Therefore, the transaction account of a provider refers to both the transaction account of a provider and the transaction account of a third party (e.g., a travel co-ordinator or merchant) associated with the provider.

If the provider has a transaction account, the transaction account may also be included (i.e., stored) in the provider device 104. For example, a mobile device (which is a provider device 104) may have the transaction account of the provider stored in the mobile device.

In one example arrangement, the provider device 104 is a computing device in a watch or similar wearable and is fitted with a wireless communications interface (e.g., a NFC interface). The provider device 104 can then electronically communicate with the requestor to make request regarding the transaction request by pressing a button on the watch or wearable.

The acquirer server 106 is associated with an acquirer who may be an entity (e.g. a company or organization) which issues (e.g. establishes, manages, administers) a payment account (e.g. a financial bank account) of a merchant. Examples of the acquirer include a bank and/or other financial institution. As discussed above, the acquirer server 106 may include one or more computing devices that are used to establish communication with another server (e.g., the transaction processing server 108) by exchanging messages with and/or passing information to the other server. The acquirer server 106 forwards the payment transaction relating to a transaction request to the transaction processing server 108.

The transaction processing server 108 is configured to process processes relating to a transaction account by, for example, forwarding data and information associated with the transaction to the other servers in the system 100 such as the locating server 140. In an example, the transaction processing server 108 may transmit data relating to a request message such as a travel co-ordination request or a KNN query (e.g. date, time, location information of the user making the request or query, and other similar data) to the locating server for processing to locate moving objects that are in proximity to the user location. The transaction processing server 108 may use a variety of different protocols and procedures in order to process the payment and/or travel co-ordination requests. It will be appreciated that payment for a transaction may be made via a variety of methods such as credit cards, debit cards, digital wallets, buy-first pay-later schemes, and other similar payment methods. In an implementation, the transaction processing server 108 may be further configured to perform the functions of the locating server 140, such that the locating server 140 is not required.

The issuer server 110 is associated with an issuer and may include one or more computing devices that are used to perform a payment transaction. The issuer may be an entity (e.g. a company or organization) which issues (e.g. establishes, manages, administers) a transaction credential or a payment account (e.g. a financial bank account) associated with the owner of the requestor device 102. As discussed above, the issuer server 110 may include one or more computing devices that are used to establish communication with another server (e.g., the transaction processing server 108) by exchanging messages with and/or passing information to the other server.

The reference database 150 is a database or server associated with an entity (e.g. a company or organization) which manages (e.g. establishes, administers) data relating to users, transactions, products, services, and other similar data, for example relating to the entity. In an arrangement, the reference database 150 may comprise data that is utilized by the locating server 140 for adaptively locating a moving object relative to a target object. For example, the moving object storage and Association Directory may be stored in the reference database 150. For example, data relating to the moving object storage and Association Directory such as map data, object spatial data, data relating to associations between each object to a corresponding graph partition, may be stored in the reference database 150. Further, data relating to OSM graphs may also be stored in the reference database 150.

Advantageously, the system 100 enables a road network to be efficiently partitioned into reasonably sized partitions while actively maintaining the association between an object's location to the road network and to the road network partitions, reducing a KNN query's search space significantly, and hence improving runtime complexity.

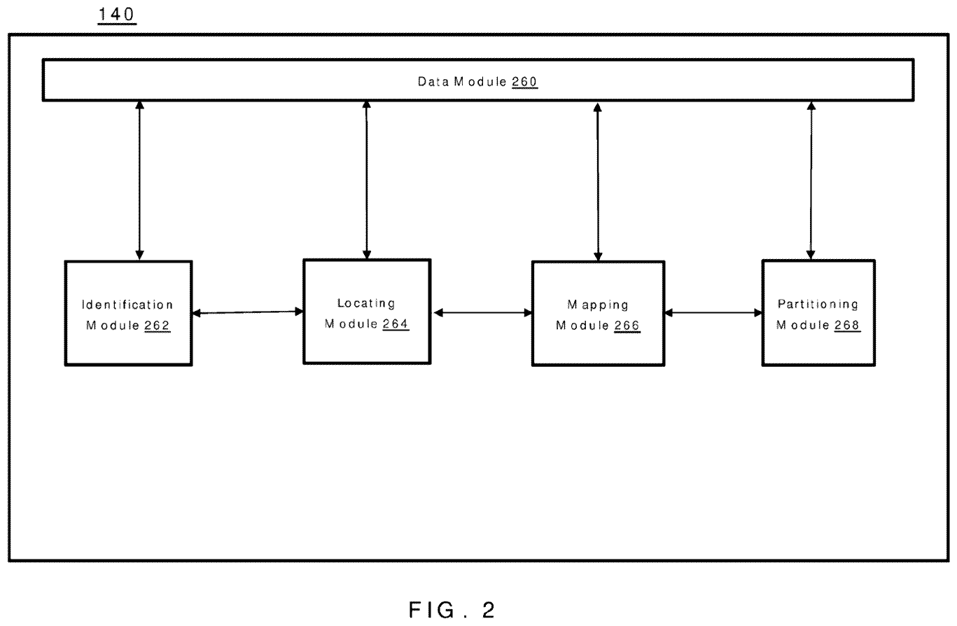

FIG. 2 illustrates a schematic diagram of an example locating server 140 according to various embodiments. The locating server 140 may comprise a data module 260 configured to receive data and information from the requestor device 102, provider device 104, transaction processing server 108, reference database 150, a cloud and other sources of information to adaptively locate a moving object relative to a target object by the locating server 140. For example, the data module 260 may be configured to receive data and information required for processing a request message from the requestor device 102, the provider device 104, transaction processing server 108, reference database 150, and/or other sources of information. The data module 260 may also be configured to retrieve data required by the request message from the reference database 150 and/or other sources of information. The data module 260 may be further configured to send information relating to data retrieved in response to the request for data to the requestor device 102, the provider device 104, the transaction processing server 108, or other destinations where the information is required.

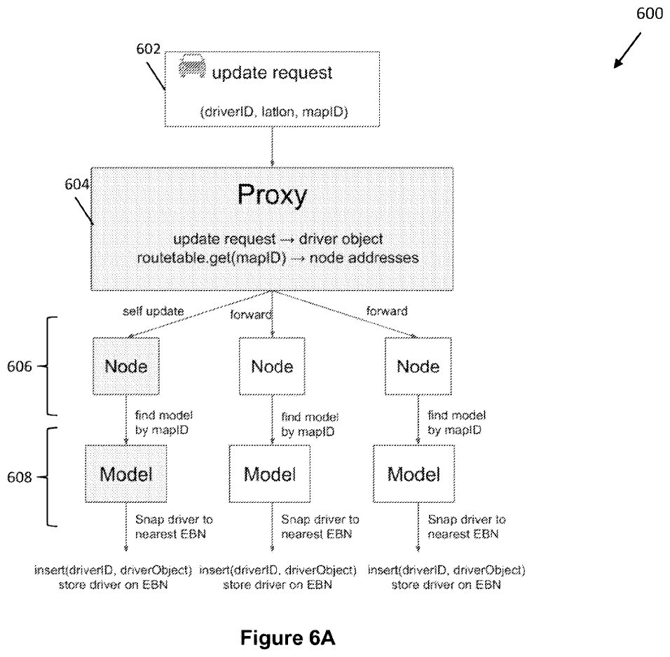

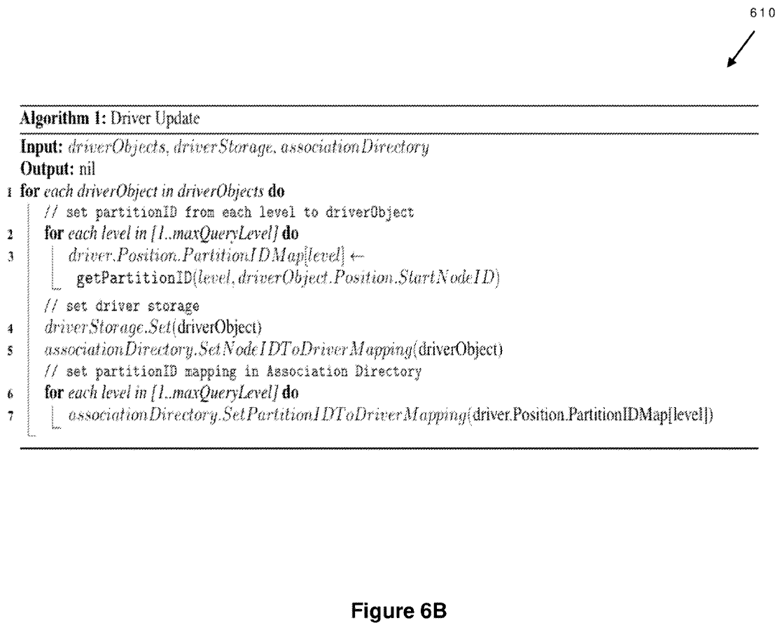

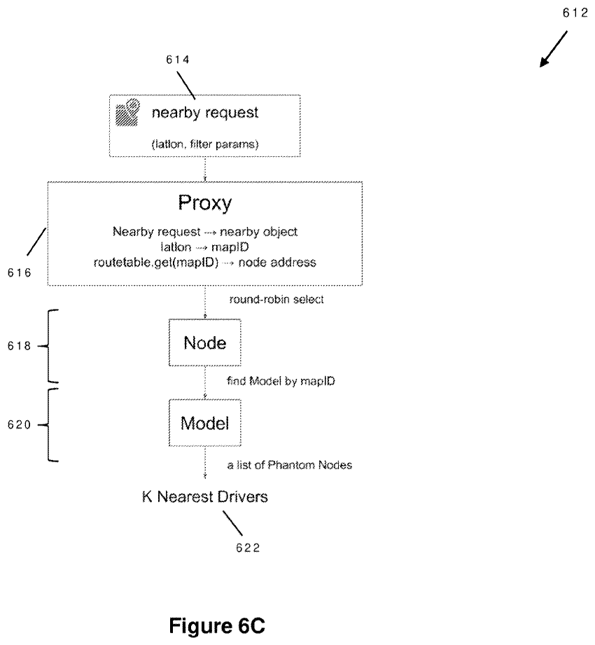

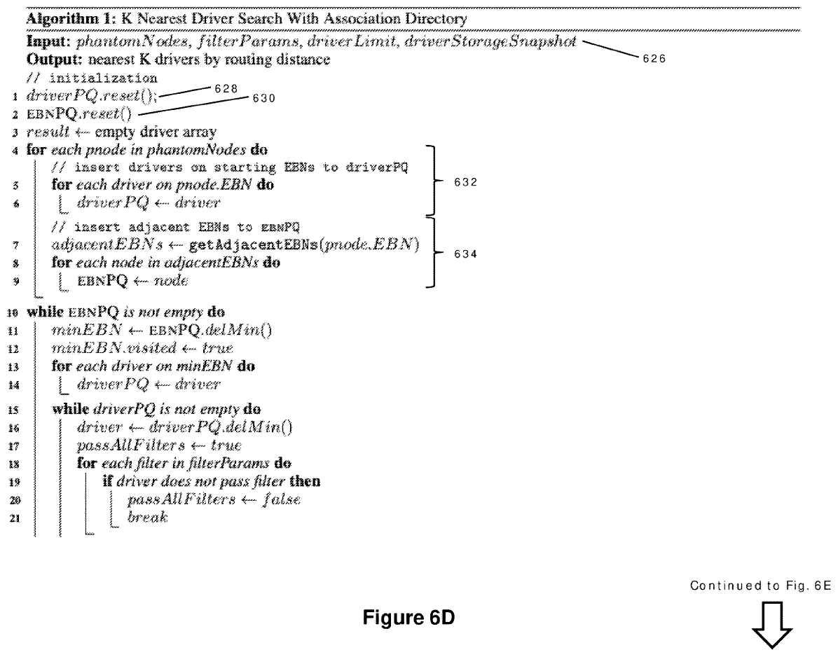

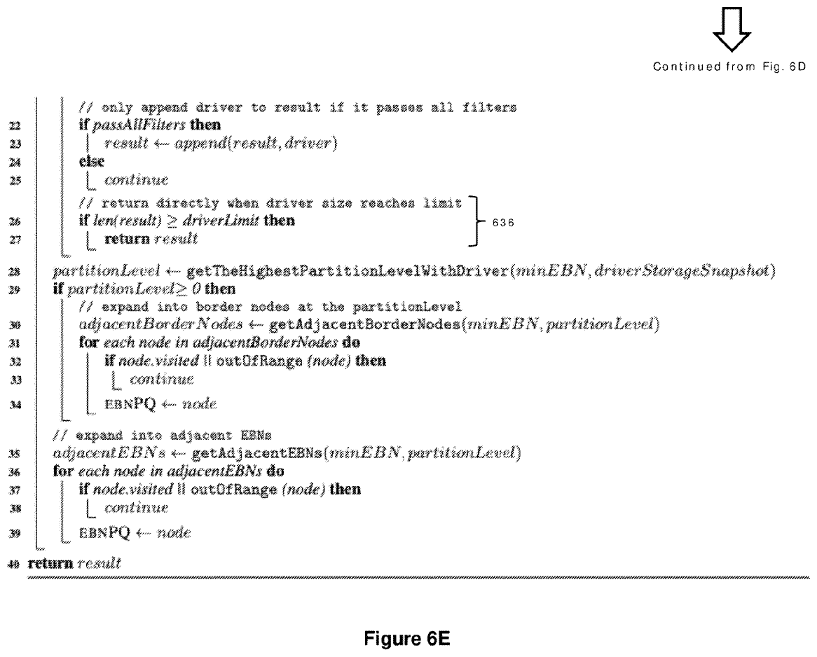

The locating server 140 may comprise an identification module 262 that is configured for identifying a latitude and longitude of a location of a target object, in response to a request message including location information of the target object, and identifying a location information of a moving object in the proximity of the target object based on the identified latitude and longitude of the target object. For example, the identification module 262 may be configured to identify the latitude and longitude from GPS coordinates corresponding to the provided location information in the request message. The identification module 262 may be further configured to identify location information of a road network that the target object is travelling on, and identify a relative distance of a starting position of the target object. The identification module 262 may be further configured to identify the moving object in closest proximity to the target object when more than one moving object is identified. The identification steps mentioned above are further explained in FIGS. 6A-6E .

The locating server 140 may also comprise an locating module 264 that is configured for adaptively locating the moving object relative to the target object based on the identified location information. The locating of the moving object relative to the target object is further explained in FIGS. 6A-6E .

The locating server 140 may also comprise a mapping module 266 that is configured for mapping the more than one moving object relative to the target object. subtracting or adding data retrieved from the first and second databases, and may be further configured for mapping the location of the target object onto the road network to get its relative location in a road graph, wherein the road graph comprises the road network. The locating server 140 may also comprise a partitioning module 268 that is configured for partitioning a graph edge based on location information of the moving information.

Each of the data module 260, identification module 262, locating module 264, mapping module 266 and partitioning module 268 may further be in communication with a processing module (not shown) of the locating server 140, for example for coordination of respective tasks and functions during the process. The data module 260 may be further configured to communicate with and store data and information for each of the processing module, identification module 262, locating module 264, mapping module 266 and partitioning module 268. Alternatively, all the tasks and functions required for adaptively locating a moving object relative to a target object may be performed by a single processor of the locating server 140.

In the present disclosure, the proposed solution is described based on utilization of Pharos© for adaptively locating a moving object relative to a target object. However, it will be appreciated that other similar applications may also be utilized.

As previously described, Pharos© uses the map which is extracted from the OSM base map for its graph representation of road topology. This base map, represented as a raw OSM protobuf file, will be processed to generate a MLD graph. Pharos© favours the MLD graph representation because (1) MLD graph is widely used and can be seamlessly integrated with Pharos©, (2) a rich set of graph details (e.g. turn restrictions, road closures) can be incorporated into MLD graph conveniently and (3) MLD graph has multiple layers to partitions to speed up routing query. These techniques are beneficial for Pharos© to support fast large distance KNN queries. An INE solution is not able to scale well if a query point is far away as the time complexity grows with the size of the expanded network. This issue is not critical as KNN queries in Pharos© typically search for a very limited area, since moving objects that are far from the pick-up point may incur high cancellation rate (e.g. cancellation of the travel co-ordination request associated with the KNN query). However, to satisfy various business requirements (e.g., nearby query for a particular type of vehicle which can be far away) it may be desirable to support KNN queries over long distances. Multiple layers of partitions in the MLD graph can be utilised to handle this scenario, although a leverage needs to be considered carefully as the indexing between the moving objects and graphs will continue to grow.

To reduce computation complexity and storage, the road network will be firstly transformed into a compressed node-based graph (CNBG) and then converted to an edge-based graph (EBG). Each node on EBG is denoted as edge-based node (EBN), which is equal to a compressed edge in the original graph. Pharos© will load the MLD graph into memory during service start. To support hyper-localized business requirements, the graph is partitioned by cities and verticals (e.g. the road network for a four-wheel vehicle is definitely different compared to a motorbike or a pedestrian). A partition key for a graph partition is denoted as a map ID.

To support the K-Nearest Neighbors (KNN) search with Association Directory algorithm, one of the requirements is to split the road network into partitions. Ideally, each partition should be a strongly connected component, meaning every node in the partition should be reachable from any other node. This guarantees the correctness of the revised KNN algorithm.

A graph partitioning algorithm may be utilized to partition the road network by repeatedly performing “natural cuts”. By using a min-cut max-flow algorithm, dense areas in the map may be identified and preserved, while preserving the natural structure of the network in each partition. As shown in illustration 300 of FIG. 3, given an original graph A 302 (e.g. considered as a level 4 partition where the whole map is enclosed by a single partition), a partition hierarchy with five layers may be created. A min-cut max-flow algorithm is performed to split A 302 (level 4) into partitions B 304 and C 306 (level 3), B 304 and C 306 will be further split into D 308, E 310, F 312 and G 314 respectively (level 2), and the operation keeps going until level 1 which contains partition H 316, 1 318, J 320, K 322, L 324, M 326, N 328, O 330. The road network is thus organized as a hierarchy of partitions where the bigger partitions at the higher level, each bigger partition containing up to 2 smaller partitions in the lower level, and the base graph is at the lowest level (level 0) where each graph node is considered a partition. Each level can be viewed as a network of interconnected partitions.

Moreover, in each partition, all border nodes (e.g. nodes that have outgoing or in-coming edges to other partitions) may be identified. For any pair of border nodes, a shortcut (in terms of travel distance/time) is pre-calculated and stored in-memory. These shortcuts will be used for skipping partitions with no object while still being able to compute travelling distance/time correctly during KNN expansion in the road network.

Before a moving object update request reaches the moving object storage layer, the “Snapping” algorithm translates the moving object's latitude and longitude to the road network's relative location which comprises the graph edgeID, relative distance to the edge's startNode and which partition at all levels the edge is enclosed by. Illustration 400 of FIG. 4A demonstrates how the moving object's latitude and longitude (e.g. represented by node 402) are snapped to the Phantom nodes 404 and 406 in the road networks. The phantom node's projection (e.g. projection of Phantom node 404) includes edgeID 408 which is a projection ratio from start node ID 410. If there are multiple phantom node candidates, the nearest (in terms of haversine distance) to the observed GPS may be selected.

Moving object data from the update request together with snapped data will be processed and stored into moving object storage 412 and Association Directory 414 as shown in FIGS. 4B and 4C respectively. Moving object storage 412 is a key-value data structure which maps a driver's ID to a corresponding driver object that will be used later during the K nearest neighbor request. The Association Directory 414 is also a key-value data structure which acts like an extension to the moving object storage 412. The Association Directory may be configured for mapping a graph edge to all moving objects currently on it (e.g. under a Node Storage 416), and maintaining the number of drivers momentarily on each partition (e.g. under a Partition Storage 418) so that, during the search phase, all moving objects on a graph edge can be quickly looked up and checked if a partition encloses any moving object.

As Pharos© is an extremely high throughput system, each node needs to handle all moving object update and moving object nearby requests for an entire city (e.g. notable mentions being Jakarta, Ho Chi Minh, Manila). Hence, the Driver Storage 412 has to handle the continuing and highly frequent stream of read and write operations. To maintain data consistency, each write and read operation is lock required. Otherwise, data corruption may occur. Moreover, since moving objects are constantly moving on the road network, during K-nearest neighbors search, cases where the same driver is repeatedly found on different locations on the road network may occur. Hence, a classic approach is to take a snapshot of the driver storage 412 and the association directory 414 to feed to the K-nearest neighbors query. This poses another challenge to designing the driver storage since taking a snapshot is a really expensive read-heavy operation on the driver storage. In short, it is a challenging task to choose the suitable data structure for the driver storage to satisfy all the requirements above. Even the most sophisticated and elegant in-memory data structures often fail to perform under the high throughput, mainly because of the read/write lock, which often leads to bad performance or even starvation.

It is possible for Pharos© to use a data structure called “Short Lived Driver Storage Swapping” which utilizes two driver storages: the first one “Writable Driver Storage” only handles “write-only” driver update requests and the second “Readable Driver Storage” for “read-only” driver nearby requests solely. Under the hood, the driver storage uses a concurrent hash map which is the one of the best performing in-memory data structures for read/write operations. The “Short Lived Driver Storage Swapping” data structure works as follow:
1. When the service starts, an empty “Writable Driver Storage” is initialized, all driver update requests will be processed and stored in the “Writable Driver Storage” for the next two seconds.
2. After two seconds has elapsed, a new empty “Temporary Writable Driver Storage” is initialized and it concurrently copies all data from the current “Writable Driver Storage” (the operation is extremely fast because of the concurrent hashmap's read/write efficiency). The ‘Writable Driver Storage” is elected to be “Readable Driver Storage” while the “Temporary Writable Driver Storage” is elected to be “Writable Driver Storage” which is in charge of processing driver storage in the next upcoming two seconds. The previous “Readable Driver Storage” will be terminated and recycled.
3. Repeat step two until the pharos© service is terminated.

In the above example, a two-second delay is implemented from the moment the driver update reaches Pharos© till it can be reflected in the nearby requests' results. Based on experiments, such delay can be an acceptable trade off since it does not negatively affect Pharos'© key metrics (e.g. booking cancellation, number of finished bookings per hour, number of drivers found by K-Nearest neighbors query).

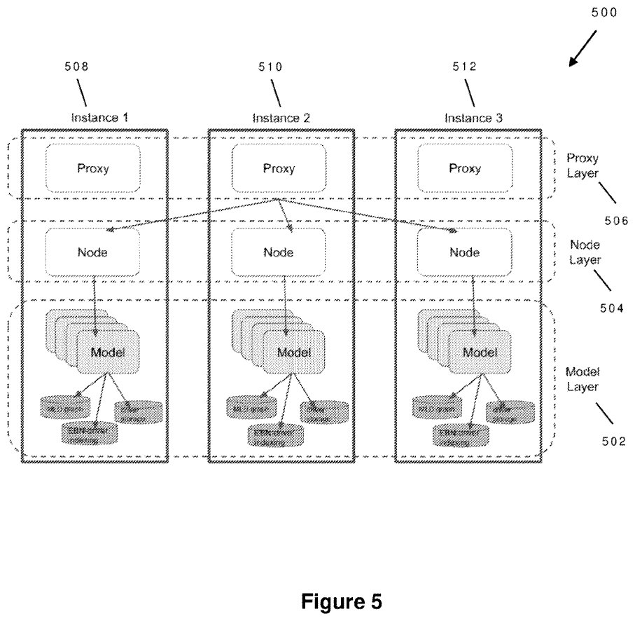

Generally, Pharos© receives requests from the upstream, performs corresponding actions and then returns the result back. Referring to illustration 500 of FIG. 5, the architecture of Pharos© is a distributed in-memory storage of drivers, and drivers are stored in a structure called Model (e.g. Model layer 502). Each Model is indexed by map ID and may be duplicated to multiple replicas (e.g. one or more other nodes in Node layer 504) for fault tolerance. For example, where three replicas are duplicated, driver updates to any of the three replicas will also be forwarded to the other two. Multiple models can be stored in the same node to optimize the resource. Each Node keeps track of the Models stored in itself using map ID as the indexing key. Each machine or instance (e.g. instances 508, 510 and 512) only contains one node. On top of Node, there is another structure called Proxy (e.g. Proxy layer 506). When a driver update request comes, it will be forwarded to the replicas as well. Proxy is designed as the component to distribute the message. In order to know which instance to forward the message to, each Proxy keeps track of a Route Table which contains the mapping from partition key (map ID) to the instance which contains the model. Route Table is dynamic which handles the situation when a new map ID is added or an existing map ID is removed.

Overall, the architecture of Pharos© can be broken down into three layers: Proxy layer 506, Node layer 504 and Model layer 502 as shown in FIG. 5. Proxy layer 506 is in charge of passing down the request to the right Node, especially when the Node is on another machine or instance; Node layer 504 stores the Models and passes the request to the right Model for execution; Model layer 502 executes the exact operation and returns the result.

Illustration 600 of FIG. 6A demonstrates a life cycle of a driver update request 602 from upstream, and illustration 610 depicts a corresponding algorithm that may be implemented for processing the driver update request 602. Driver update requests from upstream are distributed to each proxy by a load balancer and the chosen Proxy (e.g. Proxy 604 in this example) will first construct a driver object based on information indicated in the request. Each driver update request may comprise information such as a driver ID of a driver, latitude and longitude (latlon) of the driver's location, map ID, and other similar information that may be utilized for updating the driver's location in a road network. Proxy 604 uses the map ID as the key to check its Route Table and get the IP addresses of all the instances containing the node. Proxy 604 will then forward the update to other replicas (e.g. other proxies whose nodes contain replicas of the sought model). The replicas upon receiving the message, will know that the update is forwarded from another Proxy. Hence they will not check Route Table to forward the message, but directly pass down the driver object to their respective Node (e.g. in Node layer 606) instead. After passing the driver object from Proxy to Node with the right model, it will first snap the driver onto the road network and then update the driver in both Driver Storage and Association Directory. In case the Model being sought (e.g. in Model layer 608) is not found on the current machine as they are stored on other machines, nothing will be done and no error will be raised. This is because the Proxy 604 will forward the update request to those machines with this model by looking up the Route Table. In practice, Pharos© favors high throughput over strong consistency of KNN query results as the update frequency is high and slight inconsistency does not affect allocation performance significantly.

Driver Nearby request processing is the other endpoint in Pharos© which handles KNN driver queries with respect to a point. Pharos© may be configured to use a revised version of INE which utilizes the Association Directory (e.g. Association Directory 414 in FIG. 4C) for search space pruning purposes. Similar to driver update, after a driver nearby request comes from the upstream it is distributed to one of the machines or instances by a load balancer. As shown in illustration 612 of FIG. 6C, upon receiving a nearby request 614, a nearby object is built and passed to the Proxy layer 616. The driver nearby request 614 may comprise information such as a latitude and longitude (latlon) of a location, associated filter parameters, and other similar information that may be utilized for searching for nearby drivers relative to the location indicated in the driver nearby request 614. Proxy first checks the Route Table based on the indicated map ID to see if this request can be served on the current machine or instance. If so, the nearby object is passed to the Node layer 618. Otherwise, this nearby request 614 needs to be forwarded to the machines or instances which contain this map ID. A round-robin fashion is applied to select the right instance for load balancing. After the chosen machine receives the request, the Proxy layer 616 will know that this request is forwarded from another machine and directly pass the nearby object to the Node layer 618. Once the Node layer 618 receives the nearby object, it looks for the right Model using the map ID as key. Eventually, the nearby object goes to the Model layer 620 where K-nearest-driver calculation takes place. Model will snap the location of the request to some Phantom Nodes and these Nodes will be used as start nodes for expansion later.

FIGS. 6D and 6E depicts an illustration of a Driver Nearby algorithm 624 that may be implemented for processing the nearby request 614. As mentioned before, Pharos uses INE with Association Directory and those Phantom Nodes will be used as start nodes for expansion. In the algorithm 624, the Phantom Nodes, filter parameters, a maximum driver limit and driver storage snapshot may be utilized as input 626 for searching nearby drivers based on the nearby request 614. Two priority queues implemented are used in this algorithm. EbnPQ 630 is used to keep track of the nearest EBNs while driverPQ 628 keeps track of drivers on the road network by their distance to the nearby query point. Firstly, a snapshot of the current locations of the drivers (e.g. driver storage snapshot) are taken from the “Readable Driver Storage”. From each start node, a parent EBN is found and drivers on these EBNs are appended to driverPQ 628 (see reference 632). In the next step, the algorithm will scan the levels from the partition hierarchy, starting from the base map (level 0) to the highest level. In each level, the algorithm will find the partition that encloses the current EBN and check if it has any driver on it by looking up the Association Directory. This operation is to find the lowest level in which contains a partition that encloses at least one driver. Once the partition level is identified, the KNN search expands to all EBNs adjacent to the current EBN from the identified partition level (see reference 634). This is when search space pruning happens, it guarantees that the algorithm can skip empty partitions from lower levels. After repeating this process for each start node, there will be some initial drivers in driverPQ 628 and more adjacent EBNs waiting to be expanded in ebnPQ 630.

Each time the nearest EBN is removed from ebnPQ 630, drivers located on this EBN will be appended to driverPQ 628. The closest driver is also removed from driverPQ 628. If the driver passes all filtering requirements, it will be appended to the result, which is a dynamic array of drivers; otherwise just proceed on with the next closest driver. This step is repeated until driverPQ 628 becomes empty. During this process, if the size of the result reaches the maximum driver limit (see reference 636), the result will be returned. After driverPQ 628 becomes empty, adjacent EBNs of the current EBN at the same partition level are to be expanded and those within the predefined range, such as three kilometers, are appended to ebnPQ 630. Then the nearest EBN is removed from ebnPQ 630 and drivers on that EBN are appended to driverPQ 628 again. This loop continues until ebnPQ 630 becomes empty. The result will be returned to the caller.

It will be appreciated that the driver storage also includes driver's metadata, which contains driver's business related information (e.g., driver status and particular allocation preferences). In a nearby request, a set of filter parameters may be used to match with driver metadata in order to support KNN queries with various business requirements. Driver metadata also carries an update timestamp. During the nearby search, drivers with an expired timestamp may be filtered.

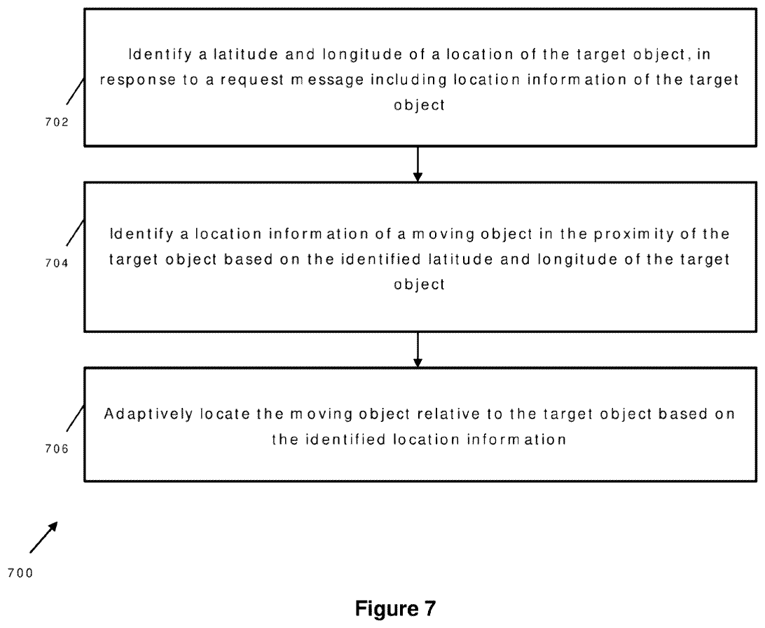

FIG. 7 illustrates an example flow diagram of a method for adaptively locating a moving object relative to a target object according to various embodiments. In a step 702, a latitude and longitude of a location of the target object is identified in response to a request message including location information of the target object. In a step 704, a location information of a moving object in the proximity of the target object is identified based on the identified latitude and longitude of the target object. In a step 706, the moving object is adaptively located relative to the target object based on the identified location information.

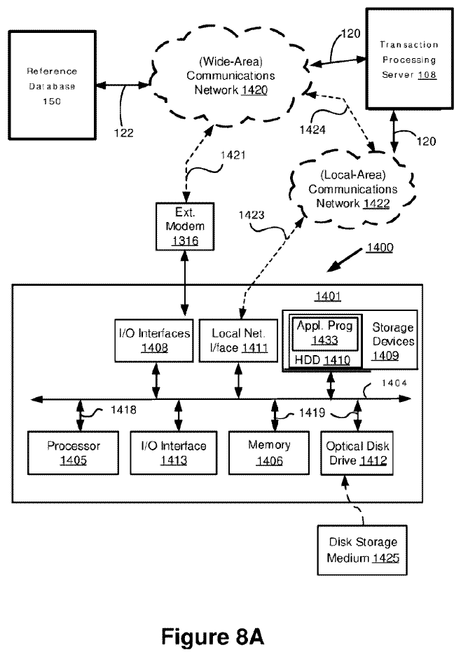

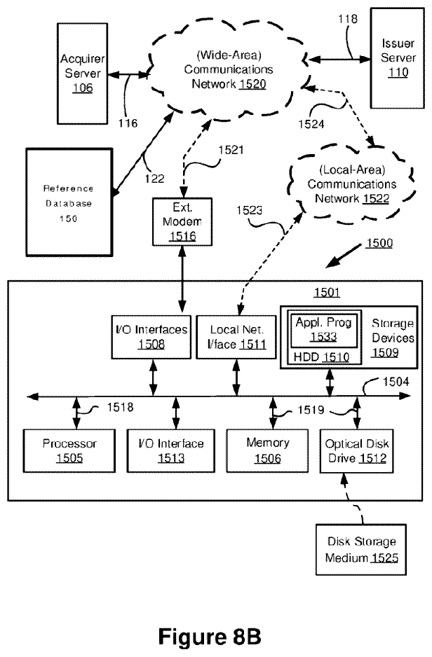

FIG. 8A depicts an example computer system 1400, in accordance with which the locating server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 8A, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1304 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 700, where performed by the locating server 140 may be implemented using the computer system 1400. The processes may be implemented as one or more software application programs 1433 executable within the computer system 1400. In particular, the sub-processes 400, 500, and 600 are effected by instructions in the software 1433 that are carried out within the computer system 1400. The software instructions may be formed as one or more code modules, each for performing one or more particular tasks. The software may also be divided into two separate parts, in which a first part and the corresponding code modules performs the methods and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for a locating server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for a locating server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the locating server 140) is presented merely by way of example. Therefore, in some arrangements, one or more features of the computer system 1400 may be omitted. Also, in some arrangements, one or more features of the computer system 1400 may be combined together. Additionally, in some arrangements, one or more features of the computer system 1400 may be split into one or more component parts.

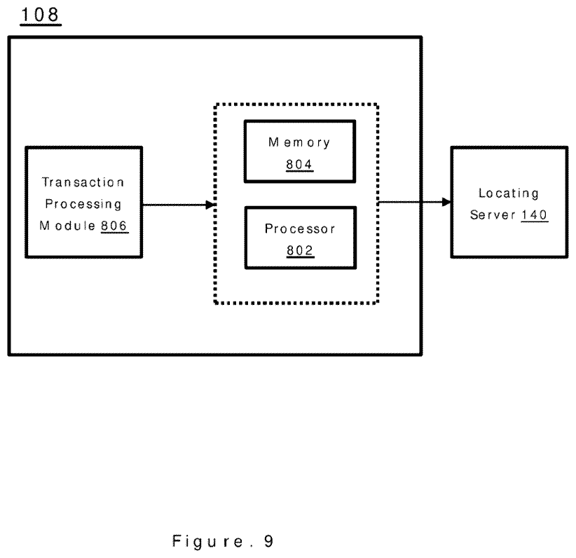

FIG. 9 shows an implementation of the transaction processing server 108 (i.e., the computer system 1300). In this implementation, the transaction processing 108 may be generally described as a physical device comprising at least one processor 802 and at least one memory 804 including computer program codes. The at least one memory 804 and the computer program codes are configured to, with the at least one processor 802, cause the transaction processing server 108 to facilitate the operations described in method 700. The transaction processing server 108 may also include a transaction processing module 806. The memory 804 stores computer program code that the processor 802 compiles to have transaction processing module 806 perform the respective functions.

With reference to FIG. 1, the transaction processing module 806 performs the function of communicating with the requestor device 102 and the provider device 104; and the acquirer server 106 and the issuer server 110 to respectively receive and transmit a transaction, travel co-ordination request message, or other similar messages. Further, the transaction processing module 806 may, instead of the requestor device 102 or provider device 104, provide data and information relating to a request message such as a request message for adaptively locating a moving object relative to a target object (e.g. date, time, location information of the target object and/or moving object, and other similar data) to the locating server 140.

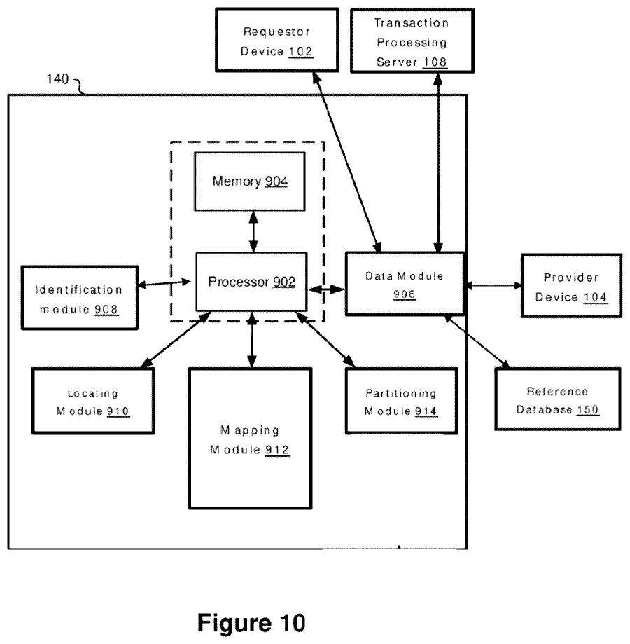

FIG. 10 shows an alternative implementation of the locating server 140 (i.e., the computer system 1400). In the alternative implementation, locating server 140 may be generally described as a physical device comprising at least one processor 902 and at least one memory 904 including computer program codes. The at least one memory 904 and the computer program codes are configured to, with the at least one processor 902, cause the locating server 140 to perform the operations described in the method 700. The locating server 140 may also include a data module 906, an identification module 908, an locating module 910, a mapping module 912 and a partitioning module 914. The memory 904 stores computer program code that the processor 902 compiles to have each of the modules 906 to 914 performs their respective functions.

With reference to FIGS. 1 to 7, the identification module 908 performs the function of identifying a latitude and longitude of a location of a target object, in response to a request message including location information of the target object, and identifying a location information of a moving object in the proximity of the target object based on the identified latitude and longitude of the target object. The identification module 908 may be further configured to identify location information of a road network that the target object is travelling on, and identify a relative distance of a starting position of the target object. The identification module 262 may be further configured to identify the moving object in closest proximity to the target object when more than one moving object is identified.

With reference to FIGS. 1 to 7, the locating module 910 performs the function of adaptively locating the moving object relative to the target object based on the identified location information.

With reference to FIGS. 1 to 7, the mapping module 912 performs the function of mapping the more than one moving object relative to the target object. subtracting or adding data retrieved from the first and second databases, and may be further configured for mapping the location of the target object onto the road network to get its relative location in a road graph, wherein the road graph comprises the road network. Further, the partitioning module 914 performs the function of partitioning a graph edge based on location information of the moving information.

With reference to FIGS. 1 to 7, the data module 906 performs the functions of receiving data and information from the requestor device 102, provider device 104, transaction processing server 108, reference database 150, a cloud and other sources of information to facilitate the method 700. For example, the data module 906 may be configured to receive data and information required for processing the request for adaptively locating a moving object relative to a target object from the requestor device 102, the provider device 104, transaction processing server 108, reference database 150, and/or other sources of information. The data module 906 may also be configured to retrieve data required by the request from the reference database 150, other databases that may be designated by the request for data, and/or other sources of information. The data module 906 may be further configured to send information relating to data retrieved in response to the request to the requestor device 102, the provider device 104, the transaction processing server 108, or other destinations where the information is required. The data module 906 may be further configured to communicate with and store data and information for each of the identification module 908, locating module 910, mapping module 912 and partitioning module 914. Alternatively, all the tasks and functions required for facilitating the method 700 may be performed by a single processor 902 of the locating server 140.

FIG. 8B depicts a general-purpose computer system 1500, upon which a combined transaction processing server 108 and locating server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 8D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 700 performed by the locating server 140 and facilitated by the transaction processing server 108 may be implemented using the computer system 1500. For example, the steps of the method 700 as performed by the locating server 140 may be implemented as one or more software application programs 1533 executable within the computer system 1500. In particular, the steps of the method 700 are effected by instructions in the software 1533 that are carried out within the computer system 1500. The software instructions may be formed as one or more code modules, each for performing one or more particular tasks. The software may also be divided into two separate parts, in which a first part and the corresponding code modules performs the steps of the method 700 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined transaction processing and locating server.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined transaction processing and locating server.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (i.e., combined transaction processing and locating server 1500) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

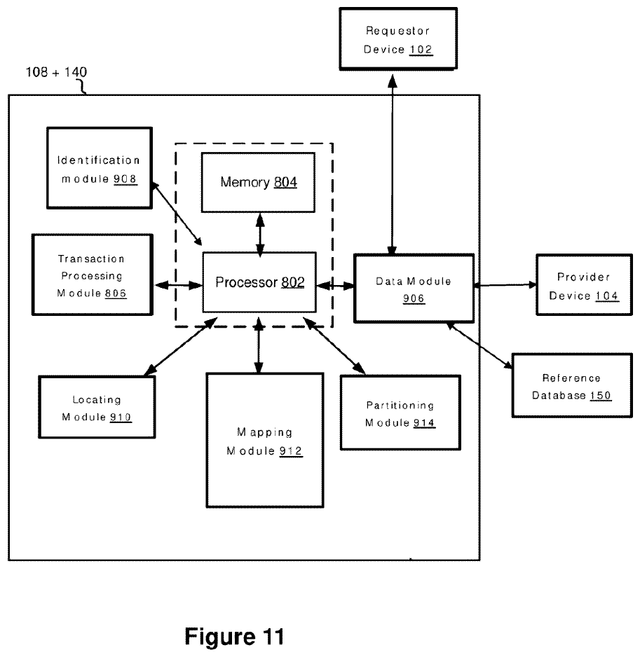

FIG. 11 shows an alternative implementation of combined transaction processing and locating server (i.e., the computer system 1500). In the alternative implementation, the combined transaction processing and locating server may be generally described as a physical device comprising at least one processor 1002 and at least one memory 904 including computer program codes. The at least one memory 1004 and the computer program codes are configured to, with the at least one processor 1002, cause the combined transaction processing and locating server to perform the operations described in the steps of the method 700. The combined transaction processing and locating server may also include a transaction processing module 806, a data module 906, an identification module 908, an locating module 910, a mapping module 912 and a partitioning module 914. The memory 1004 stores computer program code that the processor 1002 compiles to have each of the modules 806 to 912 performs their respective functions. The transaction processing module 806 performs the same functions as described for the same transaction processing module in FIG. 9. The data module 906, identification module 908, locating module 910, mapping module 912 and partitioning module 914 perform the same functions as described for the same corresponding modules in FIG. 10.

It will be appreciated by a person skilled in the art that numerous variations and/or modifications may be made to the present disclosure as shown in the specific embodiments without departing from the scope of the specification as broadly described. The present embodiments are, therefore, to be considered in all respects to be illustrative and not restrictive.

What is claimed is:

1. A method for adaptively locating a moving object relative to a target object, the method comprising:
identifying the latitude and longitude of a location of the target object, in response to a request message including location information of the target object;
identifying a location information of a moving object in the proximity of the target object based on the identified latitude and longitude of the target object; and
adaptively locating the moving object relative to the target object based on the identified location information.

2. The method according to claim 1, wherein the step of identifying the latitude and longitude of a location of the target object further comprises:
identifying location information of a road network that the target object is travelling on; and
identifying a relative distance of a starting position of target object.

3. The method according to claim 2, wherein the step of adaptively locating the moving object relative to the target object based on the identified location information further comprises:
identifying the moving object in closest proximity to the target object when more than one moving object is identified.

4. The method according to claim 3, wherein the step of adaptively locating the moving object relative to the target object based on the identified location information further comprises
mapping the more than one moving object relative to the target object.

5. The method according to claim 4, wherein the step of mapping the more than one moving object relative to the target object further comprises:
partitioning a graph edge based on location information of the moving object.

6. The method according to claim 2, further comprising:
mapping the location of the target object onto the road network to get its relative location in a road graph, wherein the road graph comprises the road network.

7. A system for adaptively locating a moving object relative to a target object, comprising:
at least one processor; and
at least one memory including computer program code;
the at least one memory and the computer program code configured to, with the at least one processor, cause the system at least to:
identify the latitude and longitude of a location of the target object, in response to a request message including location information of the target object;
identify a location information of a moving object in the proximity of the target object based on the identified latitude and longitude of the target object; and
adaptively locate the moving object relative to the target object based on the identified location information.

8. The system according to claim 7, wherein identifying the latitude and longitude of a location of the target object further comprises:
identifying location information of a road network that the target object is travelling on; and
identifying a relative distance of a starting position of target object.

9. The system according to claim 8, wherein adaptively locating the moving object relative to the target object based on the identified location information further comprises:
identifying the moving object in closest proximity to the target object when more than one moving object is identified.

10. The system according to claim 9, wherein adaptively locating the moving object relative to the target object based on the identified location information further comprises:
mapping the more than one moving object relative to the target object.

11. The system according to claim 10, wherein the step of mapping the more than one moving object relative to the target object further comprises:
partitioning a graph edge based on location information of the moving object.

12. The system according to claim 8, further configured to:
map the location of the target object onto the road network to get its relative location in a road graph, wherein the road graph comprises the road network.
